(19) United States
(12) Patent Application Publication
(10) Pub. No.: US 2004/0170488 A1
(43) Pub. Date: Sep. 2, 2004

(54) Cutting screw

(76) Inventors: To Ha Loi, Victoria (AU); David Bate, Victoria (AU)

Correspondence Address: Edwin D Schindler, Five Hirsch Avenue, P O Box 966, Coram, NY, 11727-0966, US

(21) Appl. No.: 10/479,113

(22) PCT Filed: Nov. 16, 2001
(86) PCT No.: PCT/AU01/01485

(30) Foreign Application Priority Data
May 30, 2001 (AU) PR5341

(51) Int. Cl. F16B 25/10

(52) U.S. Cl. 411/387.2

(57) ABSTRACT

Screw (10) for use in the attachment of synthetic sheet materials to a supporting structure wherein screw (10) is manufactured in integral pressed form. Screw (10) includes head (50), shank (30) and tip (12) and is provided which at least one cutting member (20) which extends radially outward from shank (30). Cutting member (20) is separated from head (50) by a distance sufficient to accommodate washer (40) and cuts an aperture in the synthetic sheet material to allow the material to expand and contract without consequent damage from shank (30). Screw (10) further includes thread (11) extending to tip (12) with at least one cutting surface (15) extending through thread (11) adjacent tip (12) for penetrating and self tapping into wood or metal supporting structures.

### TECHNICAL AREA

This invention relates to the area of building materials and in particular to a screw for use in fastening non metallic synthetic sheet materials to wood or metal, said sheet material being manufactured from polycarbonate, polyvinylchloride (PVC), fibreglass (GRP) and the like.

### BACKGROUND TO THE INVENTION

It is well known for screws which are used to attach sheet materials, for example corrugated iron, to roof battens, to passthrough the ridges of such corrugated material and be provided with a sealing washer device of a compressible material underneath the relatively broad screw head thereby minimising the possibility of leakage through such roofs.

It is common also for such a bolt or screw to take the form of a self-tapping screw which is tightened until a good seal is provided This however presents difficulties when used in conjunction with more brittle sheet materials manufactured from synthetic materials as the passage of the screw through the material may cause damage to the material adjacent the screw. In addition thermal expansion and contraction can cause damage to these materials adjacent a screw device passing therethrough.

For convenience sake these non metallic materials will be referred to herein as synthetic materials, this term being taken to include polycarbonate, PVC and GRP and similar materials.

These sheet materials, whether for roofing or for wall panels or whatever, have the common feature that compared with a product like metal corrugated sheet material, the synthetic corrugated sheet materials are relatively brittle. This means that, when the standard roofing type screw is tightened for the attachment of a synthetic panel to a batten, there is a risk of damaging the material by crazing of the material.

### OUTLINE OF THE INVENTION

It is an object of this invention to provide an improved screw which is specifically intended for use with synthetic sheet materials and which minimises the problems of damage caused by previous such screws.

The invention in one aspect is a screw for use in the attachment of synthetic sheet materials which screw is manufactured in integral pressed form and which screw includes a head, a shaft and tip and is provided with at least one cutting member which extends radially outward from the shaft and is separated from the head by a distance sufficient to accommodate a washer device.

It is preferred that the washer device if used be compressible.

It is preferred that there be two of the said cutting members lying in the same plane such that their diameter is greater than the diameter of the screw shank.

It is further preferred that these cutting members have cutting edges which are directed downwards relative to the head and are able to cut through synthetic sheet material,

While it is preferred that the head of the screw be of the standard shape of a roofing screw, any relatively broad such head would suffice. It is also preferred that a substantial part of the screw be self-tapping in nature and it may be preferred that the screw tip be shaped to act as a drill bit.

The invention in another aspect is a screw for use in the attachment of synthetic sheet materials which screw is manufactured in integral pressed form and which screw includes a head, a shaft and tip and is provided with at least one cutting member which extends radially outward from the shaft and is separated from the head by a distance sufficient to accommodate a washer device said screw being able to be used to penetrate both wood and metal by the provision of a screw thread which extends basically to the tip of the screw with at least one cutting surface extending through this thread adjacent the screw tip.

It is preferred that two such cutting surfaces be provided on opposite sides of the screw shank to facilitate the drilling capabilities of the screw. It is further preferred that the washer device if used be compressible.

In order that the invention may be more readily understood we will describe by way of non limiting example one specific embodiment thereof with reference to the accompanying drawings.

### BRIEF DESCRIPTION OF THE DRAWING FIGURES

FIG. 1 Shows an embodiment of the screw of the invention with washer in situ;

FIG. 2 Shows the upper portion of an embodiment of the invention;

FIG. 3 Shows the screw of the invention with its drill bit type tip;

FIG. 4 Shows an embodiment of the invention having coplanar cutting members;

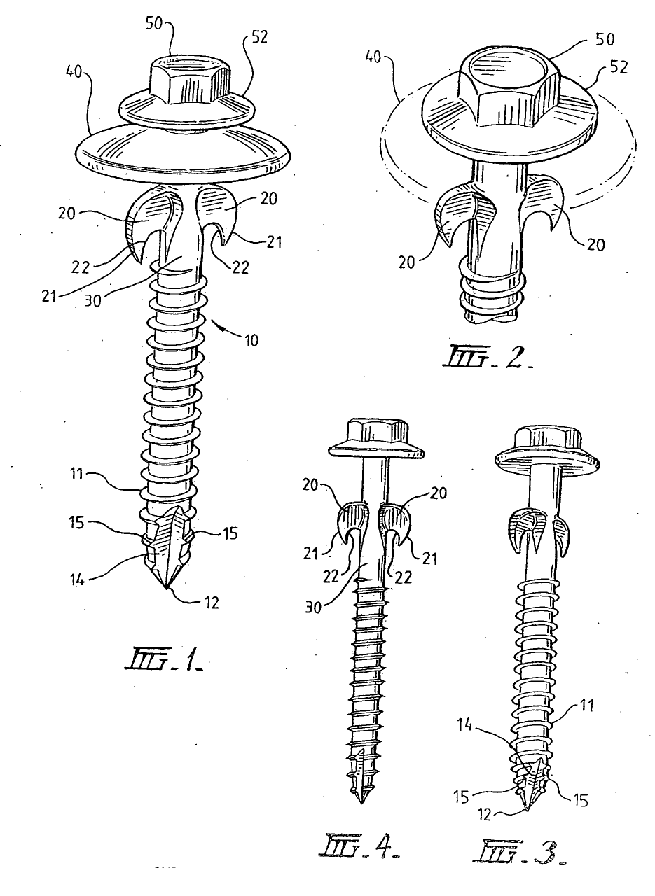

The preferred embodiment of the invention as shown in FIG. 3 is a screw 10 suitable for attaching corrugated synthetic roofing material to either metal or wooden battens,

This is achieved by the provision of a screw thread 11 which extends basically to the tip of the screw 12 with a cutting surface extending through this thread. The continuous screw thread 11 is partially excised 14, relatively to a standard screw, on either side of the screw adjacent the tip of the screw so that a cutting portion 15 is created on either side of the screw. Consequently the area of the screw 10 adjacent the area of the tip 12 forms an effective drill bit as shown in FIG. 3.

In the embodiment of the screw described here the tip of the shank is provided with cutting serrations 15 on either side over a distance of several millimetres Above this area a standard tapping screw type flite 11 is provided which terminates some two thirds of the way along the shank of the screw.

The arrangement is such that where a wooden batten is being used the screw will self tap soon after first contact while, where a metal batten is being used, an aperture will first need to be cut and then the screw will self tap.

Above the drill area of the screw two coplanar cutting members 20 are located on either side of the shank 30 of the screw, as shown in FIG. 4, and extend laterally from the shank. These members 20 are directed downwards at their outer extremities 21 and provide cutting edges 22 along the inner faces and tips of the cutting members on either side of the screw such that, as it is screwed into a batten or the like and tightened up, ultimately these cutting elements will encounter the corrugated roofing material and cut through it.

The reason that the provision of such cutting edges is desirable is twofold. Firstly a larger aperture is provided in the synthetic material than that which would be achieved using a standard self tapping screw of this nature, thereby allowing the material to expand and contract without consequent damage to the material. Additionally it is customary to drill a smaller hole through which the shaft of a self-tapping screw may pass thereby requiring a person to use two tools, one to drill the initial hole and another to drive the screw.

By means of the screw of the invention the drill point of the screw will pass through the synthetic material and into either a metal or wooden batten or the like and it is only when the wider cutting edges encounter the synthetic material that they commence to cut a hole of the same diameter as themselves in that material. Therefore only one tool is required and additionally the sheet material is protected from damage.

The screw of the invention has standard head 50, as shown in FIG. 2, with a broad base 52 designed to prevent water penetrating into a screw hole. Between this broad base 52 and the cutting members 20 is located a pad or washer 40 of compressible material which is usually of rubber but may be of any particular material desired. As a screw is tightened the washer extends laterally and covers the hole cut in the material by the two cutting elements.

As the screw of the invention cuts a broader hole through the sheet material than would normally occur with the type of screw used for a metal sheet or panel, it can be seen that the load placed on the edge of this material by the pressure of the screw head on the compressible pad or washer below is evenly distributed over a large area of the roofing material and, while it acts to adequately seal the larger diameter hole from any leakage, it does not cause the pressure forces on, that material that the head of a standard roofing screw would do.

The remainder of the screw device below the cutting edges is of a more or less like a standard type of self tapping screw such as is conventionally used for such applications and will tightened into a frame or batten as required.

The screw of the invention provides a simple means of incorporating a larger diameter aperture in synthetic sheet material than the hole size into which a screw is tapped into a batten or the like in a single operation. By this means not only is pressure more evenly distributed around a larger area of the roofing material but thermal expansion and contraction of the material can occur while damage to it such as cracking and crazing is minimised. The screw of the invention thereby acts both to minimise damage to the roofing material used and also to achieve this in an efficient manner.

Another major advantage of the screw of the invention is that it can be pressed from sheet metal material in a single discrete action rather than be moulded and assembled from separate parts. The washer of course must be added separately.

While we have described herein one particular embodiment of the cutting screw device, and in particular an application as a roofing screw, this type of screw can be used to attach any kind of synthetic sheet material to battens or the like.

It is further envisaged that other embodiments of the invention could exhibit variations in the features described. For example there may be more than two cutting elements provided, the shape of these may vary and so on. It is however envisaged that other embodiments of the invention will exhibit any number of and combination of the features previously described and it is to be understood that variations and modifications in this can be made without departing from the spirit and scope thereof.

The claims defining the invention are as follows:

1. A screw for use in the attachment of synthetic sheet materials which screw is manufactured in integral pressed form and which screw includes a head, a shaft and tip and is provided with at least one cutting member which extends radially outward from the shaft and is separated from the head by a distance sufficient to accommodate a washer device.

2. A screw as claimed in claim 1 having two coplanar cutting members with a combined greater than the diameter of the screw shank.

3. A screw as claimed in claim 1 or claim 2 wherein the cutting members have cutting edges which are directed towards the tip of the screw which cutting members are adapted to cut through synthetic sheet material.

4. A screw as claimed in any one of claims 1 to 3 wherein the head of the screw is of the standard shape of a roofing screw.

5. A screw as claimed in any one of claims 1 to 4 wherein at least part of the screw shank is self-tapping in nature.

6. A screw as claimed in claim 5 wherein an area of the shank adjacent the screw tip is shaped to act as a drill bit such that the screw is able to be used to penetrate both wood and metal by the provision of a screw thread which extends basically to the tip of the screw with at least one cutting surface extending through this thread adjacent the screw tip.

7. A screw as claimed in claim 6 wherein two cutting surfaces are provided on opposite sides of the screw shank.

8. A screw for use in the attachment of synthetic sheet materials which screw is manufactured in integral pressed form said screw including a head, a shaft and tip, said screw being able to be used to penetrate both wood and metal by the provision of a screw thread which extends substantially along the shank to the tip of the screw with at least one cutting surface extending through this thread adjacent the screw tip such that an area adjacent the screw tip acts as a drill bit.

9. A screw as claimed in claim 7 wherein two cutting surfaces are provided on opposite sides of the screw shank in the area of the shank adjacent the drill tip which acts as a drill bit.

10. A screw as claimed in any one of claims 1 to 9 wherein a compressible washer device is located between the screw head and any said cutting member.

11. A screw as claimed in any one of claims 1 to 10 wherein the screw is manufactured in integral form from pressed metal.
